(19) United States
(12) Patent Application Publication
(10) Pub. No.: US 2007/0121241 A1
(43) Pub. Date: May 31, 2007

(54) Disk drive having a magnetic head for perpendicular magnetic recording

(75) Inventor: Takeshi Abe, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/601,785

(22) Filed: Nov. 20, 2006

(30) Foreign Application Priority Data
Nov. 28, 2005 (JP) 2005-342359

(51) Int. Cl. G11B 20/20; G11B 5/187

(52) U.S. Cl. 360/76; 360/122

(57) ABSTRACT

According to one embodiment, a disk drive is provided which realizes an effective variable track pitch structure of a perpendicular magnetic recording system. The disk drive uses a magnetic head including a write head having a main magnetic pole structure with a bottom surface formed to have a trapezoidal or triangular shape. Tracks are recorded by the write head on a disk medium at a variable track pitch set based on the size of the bottom surface of the main magnetic pole structure, skew angle and bevel angle.

### CROSS-REFERENCE TO RELATED APPLICATIONS

This application is based upon and claims the benefit of priority from Japanese Patent Application No. 2005-342359, filed Nov. 28, 2005, the entire contents of which are incorporated herein by reference.

### BACKGROUND

1. Field

One embodiment of the invention relates to a disk drive having a perpendicular magnetic recording system.

2. Description of the Related Art

Generally speaking, in a small-type disk drive in particular, a magnetic head for performing data read/write operation on a disk medium is mounted on a rotary type actuator. The rotary type actuator is so operated as to allow the write operation magnetic head to swing in a radial direction over a turned disk medium and, by doing so, the head is located to a target position.

Where the rotary type actuator is used, the magnetic head located over the disk medium involves a so-called skew angle and encounters an interval variation relative to an adjacent track corresponding to the radial position over the disk medium. In more detail, an increase in screw angle results in a decrease in the effective track width (effective data track width).

Where a greater number of tracks are formed on the disk medium surface, a variable track pitch system for varying a track pitch according to the radial position over the disk medium has been proposed as a method of increasing the track recording density so as to consider the skew angle (see JPT PAT APPLN KOKAI PUBLICATION NO. 11-25609).

In a disk drive of a perpendicular magnetic recording system, a magnetic head is mounted on a slider with a data read only read head and perpendicular magnetic recording type write head separated thereon. The write head performs the perpendicular magnetic recording on the disk medium at the bottom surface of a main magnetic pole structure for generating a perpendicular recording magnetic field. In the so-called footprint recording, that is, in the recording made at the bottom surface of the main magnetic pole structure, as the skew angle becomes larger, it exerts a greater adverse effect on an adjacent track.

In the disk drive of the perpendicular magnetic recording system, if use is made of a write head having a bevel angle defined by working the main magnetic pole structure to a trapezoidal or triangular shape, there is a tendency, on the other hand, that, as the skew angle becomes larger, the effective track width becomes greater. If, on one hand, the bevel angle becomes larger, the area of the main magnetic pole structure is decreased and the perpendicular magnetic recording capability is lowered. In the disk drive of the perpendicular magnetic recording system it is not possible to enhance the track recording density of the disk medium simply by using a variable track pitch configuration capable of a track pitch variation on the basis of the skew angle.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing an arrangement of a disk drive according to an embodiment of the present invention;

FIG. 2 is a view for explaining a structure of a magnetic head according to the present embodiment;

FIGS. 3A and 3B are views for explaining a main magnetic pole structure of a write head according to the present embodiment;

FIG. 4 is a view for explaining a positional relation showing a write head relating to the present embodiment which is mounted on an actuator;

FIGS. 5A and 5B are views for explaining a practical example of a variable track pitch relating to the present embodiment;

FIG. 6 is a view for explaining a relation between a track pitch relating to the present embodiment and a skew angle;

FIG. 7 is a view for explaining a relation between a track pitch relating to the present embodiment and a track density;

FIG. 8 is a view explaining a process of deriving a relation equation between a track pitch relating to the present embodiment and respective parameters of a main magnetic pole structure;

FIG. 9 is a view for explaining a process of deriving a relation equation between a track pitch relating to the present embodiment and respective parameters of a main magnetic pole structure; and

FIG. 10 is a view for explaining a process of deriving a relation equation between a track pitch relating to the present embodiment and respective parameters of a main magnetic pole structure.

### DETAILED DESCRIPTION

Various embodiments according to the invention will be described hereinafter with reference to the accompanying drawings. In general, according to one embodiment of the invention, there is provided a disk drive of a perpendicular magnetic recording system which can realize an effective variable track pitch configuration for a perpendicular magnetic recording system and realize a higher track recording density.

An embodiment of the present invention will be explained below with reference to the drawings.

(Structure of Disk Drive)

FIG. 1 is a block diagram showing a structure of a disk drive relating to the present embodiment.

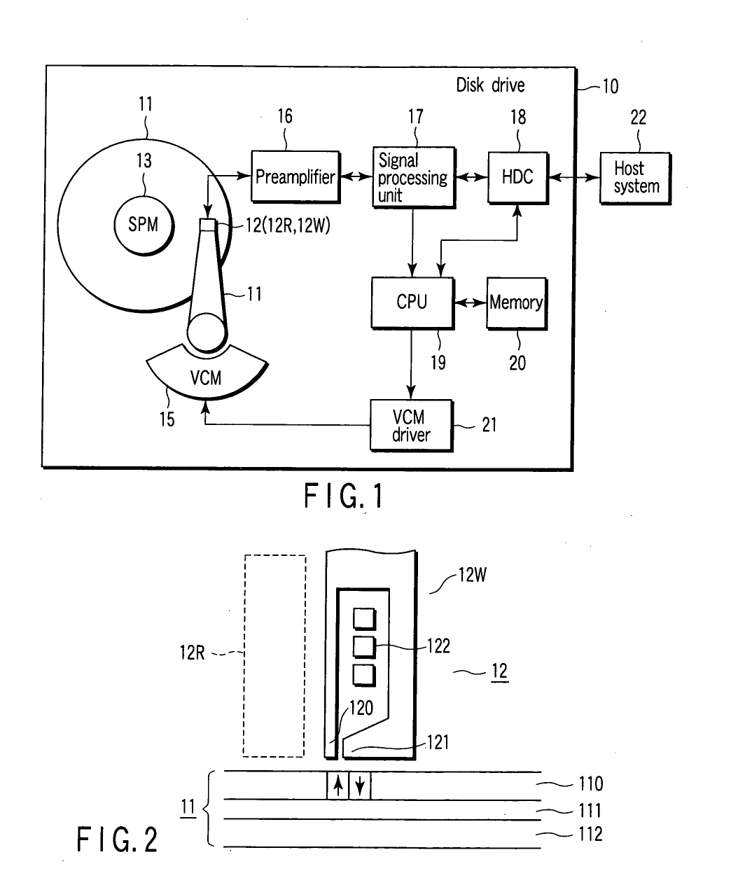

The disk drive 10 of the present embodiment is comprised of a hard disk drive using a disk medium 11 capable of perpendicular magnetic recording. The disk medium 11 is fixed in place on a spindle motor (SPM) 13 and it is incorporated within a disk drive 10 to allow high speed rotation. The disk medium 11 is comprised of, as shown in FIG. 2, a laminate structure, on a nonmagnetic substrate, of a soft magnetic layer 112, an intermediate nonmagnetic layer 111 and a perpendicular recording layer 110. The perpendicular recording layer 110 is an area for magnetically recording data corresponding to a perpendicular recording magnetic field from a write head 12W as will be set out below.

Here, a greater number of tracks are provided on the disk medium 11 for data recording by a write head 12W. In the present embodiment, as will be set out below, the track pitch of a track-to-track interval is varied in accordance with a radial position over the disk medium 11.

The disk drive 10 has a magnetic head 12 including, relative to the disk medium 11, a read head 12R for reading out data (servo information and user data) and a write head for writing data. The magnetic head 12 is mounted on an actuator 14 driven by a voice coil motor (VCM) 15. The VCM 15 has its drive current supplied from a VCM driver 21 so as to be driven under control. The actuator 14 is a head moving mechanism driven under control of a microprocessor (CPU) 19 to allow the magnetic head 12 to be located to a target position (target track) of the disk medium 11.

In addition to the head disk assembly, the disk drive 10 also has a preamplifier circuit 16, a signal processing unit 17, a disk controller (HDC) 18, CPU 19 and memory 20.

The pre-amplifier circuit 16 has a read amplifier for amplifying a read data signal which is output from the read head 12R of the head 12 and a write amplifier which supplies a write data signal to the write head 12W. The signal processing unit 17 is comprised of a signal processing circuit for processing a read/write data signal (including a servo signal corresponding to the servo information) and also called a read/write channel.

HDC 18 has an interface function between the drive 10 and a host system 22 (for example, a personal computer and various kinds of digital devices). The HDC 18 executes the transfer control of read/write data between the disk 11 and the host system 22.

The CPU 19 is comprised of a main controller of the drive 10 and executes the head positioning control and normal read/write operation of the user data under control. That is, the CPU 19 is comprised of a practical means which, in order to allow the track pitch of the tracks on the disk medium 11, to vary, effects the head positioning control and data write operation control.

The memory 20 includes, in addition to a flash memory (EEPROM) of a nonvolatile memory, a RAM, ROM, etc., and retains various kinds of data and program necessary to control the CPU 19.

(Structure of Magnetic Head)

FIG. 2 is a view for explaining a structure of the magnetic head 12 relating to the present embodiment.

The magnetic head 12 is comprised of a structure mounted on a slider, not shown, with the write head 12W and read head 12R separated. The read head 12R is constructed of a read only head and, normally, a GMR (giant magnetoresistive element).

Write head 12W is comprised of a single pole type head suitable to the perpendicular magnetic recording and has a main magnetic pole structure (recording magnetic pole structure) 120, a return yoke having a trailing-side magnetic pole structure 121 corresponding to auxiliary magnetic pole structure, and exciting coil 122. The write head 12W is such that, in the running direction (the right direction of FIG. 2) of the disk medium 11, a trailing-side magnetic pole structure 121 is set at the rear end side and the main magnetic pole 120 is set on the leading end.

The main magnetic pole structure 120 is comprised of a soft magnetic material of a relatively high magnetic permeability, allowing the excitation of a perpendicular write magnetic field corresponding to a write current flowing through the exciting coil 122. In the present embodiment, as will be set out below, the main magnetic pole structure 120 is of such a type that the bottom surface facing the surface of the disk medium 11 is worked to have a trapezoidal or triangular shape.

(Main Magnetic Pole Structure)

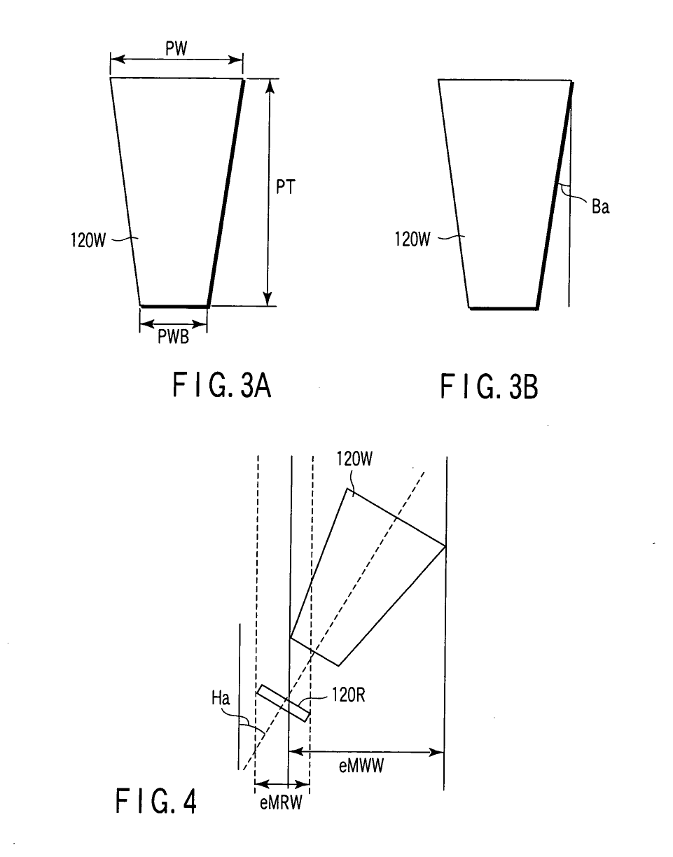

Referring to FIGS. 3A to 10, an explanation will be made below about the structure of the main magnetic pole structure 120 at the write head 12W of the present embodiment.

FIGS. 3A and 3B are views showing a bottom surface 120W, facing the surface of the disk medium 11, at the main magnetic pole structure 120 of the write head 12W of the present embodiment. Further, the bottom surface 120W may be worked to have a triangular shape.

Here, those parameters on the main magnetic pole structure 120 are: PW, the upper base width of the bottom surface 120W; PT, the main magnetic pole length, and PWB, the lower base width, as shown in FIG. 3A. And, as shown in FIG. 3B, Ba represents a bevel angle based on the upper base width PW, main magnetic pole length PT and lower base width PWB.

FIG. 4 is a view showing that, in a state mounted on the actuator 14, a positional relation of a read element 120R of the read head 12R and bottom surface 120W of the main magnetic pole structure 120 over the disk medium. In FIG. 4, respective parameters are defined with a skew angle Ha given in the case where, over the disk medium, the magnetic track width of the write head 12W is represented by MWW and the magnetic read width of the read head 12R by MRW.

Here, in general, the magnetic track width MWW and upper base width PW of the main magnetic pole structure 120 have a relation of [MWW≧PW]. And the magnetic read width MRW and read width RW of the read element 120 have a relation of [MRW≧RW]. And the magnetic head length of the write head 12W and main magnetic pole length PT have a relation of MT≧PT.

In a state with the skew angle Ha given to the magnetic head 12, as shown in FIG. 4, eMWW represents the effective track width relative to the magnetic track width MWW, and eMRW, the effective read width relative to the magnetic read width MRW.

(Main Magnetic Pole Structure and Variable Track Pitch Configuration)

In the write head 12W of the present embodiment, even if the skew angle Ha becomes larger by working the bottom surface 120W of the main magnetic pole structure 120 to a trapezoidal or triangular shape and giving the bevel angle Ba as set out above, the effective track width becomes larger as will be set out below, therefore it is possible to realize a higher track density. If, on the other hand, the bevel angle Ba is made larger, the area of the bottom surface 120W of the main magnetic pole structure 120 is decreased, thus causing a fall in the magnetic recording capability.

The present embodiment provides a variable track pitch structure for realizing a higher track recording density (TPI) while maintaining a magnetic recording capacity.

In more detail, with MWW₀, MRW₀ and MT representing the magnetic track width, magnetic read width and magnetic head length, respectively, when the skew angle Ha=0°, the track pitch Tp is set as indicated by an equation (A) bellow.
2Tp=MWW₀·cos Ha+MT\sqrt{1+tan²Ba}·sin (Ha−Ba)+MRW₀·cos Ha (A)
provided that, Ha≧Ba

Or the track pitch Tp may be so set as to satisfy the relation indicated by the following equations (B) and (C).
MWW₀·cos Ha+MT\sqrt{1+tan²Ba}·sin (Ha−Ba)+MRW₀·cos Ha≦2Tp (B)
2Tp≦MWW₀·cos Ha+MT\sqrt{1+tan²Ba}·sin (Ha−Ba)+MRW₀·cos Ha+60 (C)
provided that, Ha≧Ba

By referring to FIGS. 8 to 10, an explanation will be made below about the process of deriving an equation showing the relation between the track pitch Tp and respective parameters of the main magnetic pole structure 120.

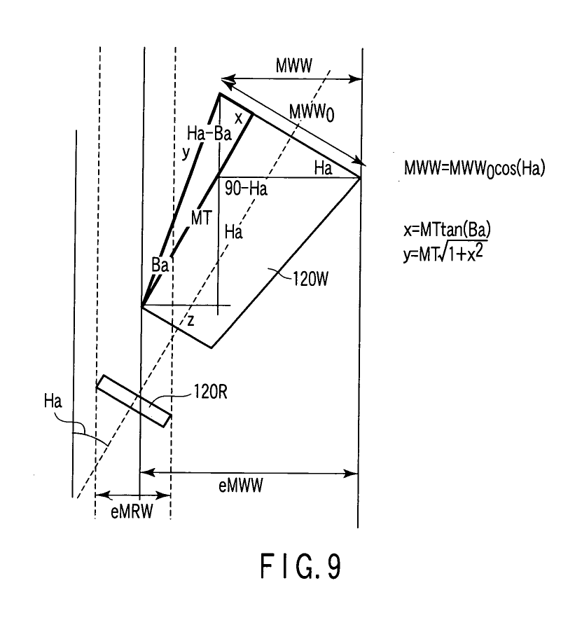

As shown in FIG. 8, the magnetic track width MWW can be calculated from cos (Ha) when the magnetic track width=MWW₀ at Ha=0°. Thus, the bevel angle Ba of the main magnetic pole structure 120 and magnetic head length MT can be expressed by the relation shown in FIG. 9.

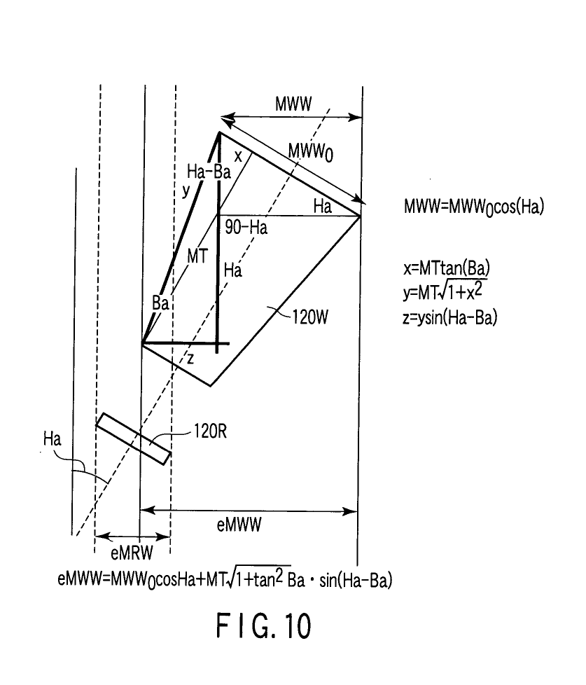

As shown in FIG. 10, the following equation D of calculating the effective track width eMWW can be derived from the relation between the skew angle Ha and the bevel angle Ba.
eMWW=MWW₀·cos Ha+MT\sqrt{1+tan²Ba}·sin (Ha−Ba) (D)

When the effective read width eMRW can be derived as the following equation (E) from cos(Ha) when the magnetic read width=MRW₀ at Ha=0°
eMRW=MRW₀·cos Ha (E)

Here, the effective track width eMWW can be derived from the following equation (F) at Ha>Ba.
eMWW=MWW₀·cos Ha (F)
provided that, Ha>Ba

When, on the other hand, the skew angle Ha≧the bevel angle Ba, the pole of the main magnetic pole structure 120 projects out to an extent given by the following equation:
MT\sqrt{1+tan²Ba}·sin (Ha−Ba) (G)
provided that, Ha≧Ba

By the deriving process above it is possible to derive the effective track width eMWW from the equation (D) above. It is possible to, from the equations (D) and (E), derive the equation (A) for setting the track pitch Tp. It is also possible to derive the relation equations (B) and (C).

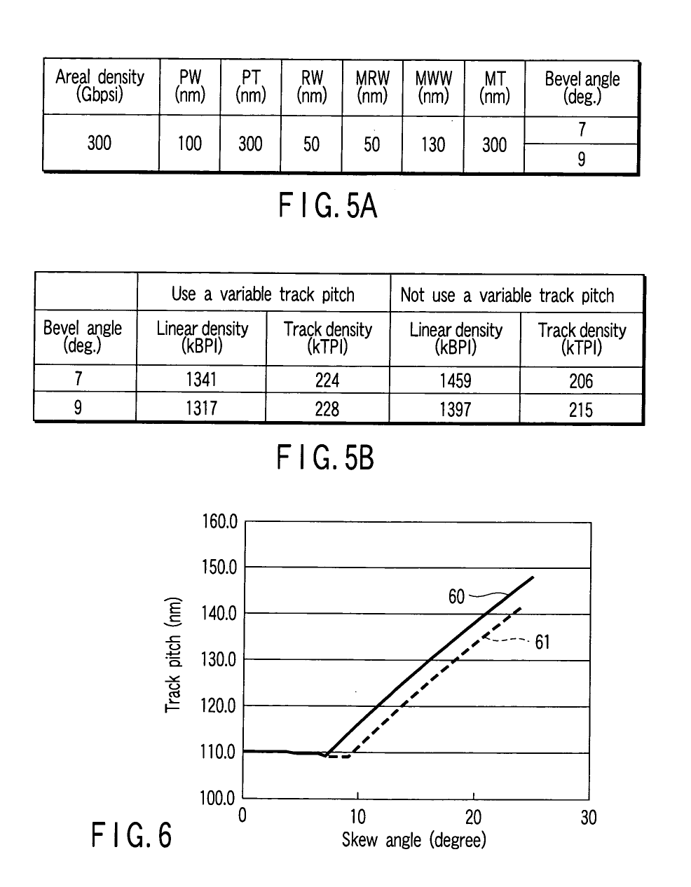

FIG. 5 is an explanatory view showing a practical case of respective parameters applied on the present embodiment and its associated track recording density.

Now suppose a disk drive 10 in which, as shown in FIG. 5A, at a target areal density of 300 Gbpsi, the radial value of a disk medium 11 is 15 to 30 mm, the skew angle Ha is −13° for the radius of 15 mm, or 13° for the radius of 30 mm, and the track group is equidistantly divided into 20 zones.

In this disk drive 10, respective parameters of the main magnetic pole structure 120 are set to be: PW=100 nm, PT=300 nm, RW=500 nm, MWW=PW+30=130 nm, MRW=RW=50 nm, and MT=PT=300 nm.

Here, FIG. 6 shows a relation between the skew angle Ha and an optimal track pitch Tp. The track pitch Tp is calculated out from a relation equation ┌2Tp−eMWW−eMRW>40┘. In FIG. 6, the solid line 60 shows the characteristic when, the bevel angel Ba, one of the paramators of the main magnetic pole structure 120, is 7°. On the other hand, the dotted line 61 shows the characteristic at the bevel angle Ba=9°. As shown in FIG. 6, the track pitch Tp is constant in a range of a relatively small skew angle Ha over the disk medium 11.

As shown in FIG. 5B, if, at Ba=7°, calculation is made to obtain the same surface capacity when the variable track pitch is not used, then the average linear density (kBPI) and average track density (kTRI) become 1459 kBPI and 206 kTPI, respectively. When, on the other hand, the variable track pitch is used, the average linear density (kBPI) and average track density (kTPI) become 1341 kBPI and 224 kTPI, respectively.

Likewise, at Ba=9°, when the variable track pitch is not used, then the average linear density (kBPI) and average track density (kTPI) become 1397 kBPI and 215 kTPI, respectively. When, on the other hand, the variable track pitch is used, the average linear density (kBPI) and average track density (kTPI) become 1317 kBPI and 228 kTPI, respectively. That is, the difference of the linear densities when the variable track pitch is not used is 118 kBPI. When, on the other hand, the variable track pitch is used, the corresponding difference is 24 kBPI only. If the variable track pitch is used, a higher track density (TPI) can be achieved without giving any relative high bevel angle Ba. That is, it is possible to obtain a high recording density without exerting any adverse effect on the magnetic head 12 and disk medium 11.

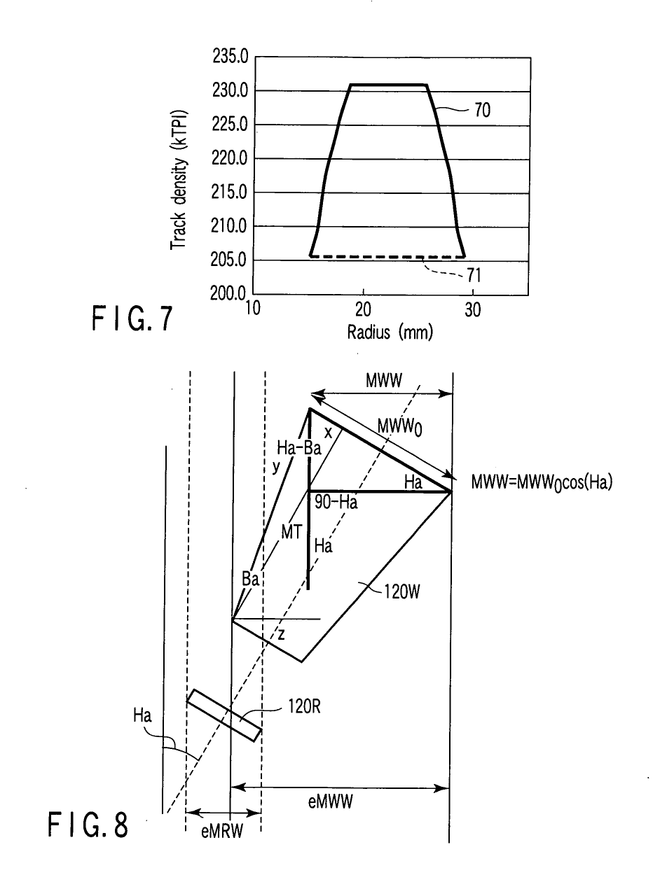

FIG. 7 shows a variation of the track density (TPI) in the radius direction on the disk medium. In FIG. 7, the dotted line 71 shows the characteristic when the variable track pitch is not used, that is, the track pitch is constant. And the solid line 70 shows the characteristic when the variable track pitch is used. As indicated by the solid line 70 in FIG. 7, a given high track density is involved at an intermediate circumferential portion of the disk medium 11 in a relatively small skew angle Ha range, and a track pitch is set variable at those inner and outer circumferential portions to allow the track density to vary.

As set out above, a track structure is realized based on the relation equation (A) and equation (B) or (C), that is, it is realized with the use of a variable track pitch Tp, taking into consideration the skew angle Ba and bevel angle Ba over the magnetic head 12 which is a parameter of the main magnetic pole structure 120. For such track structure on such disk medium 11, it is possible to achieve a relatively high track density (TPI) on the disk medium 11 while retaining a recording capacity of the main magnetic pole structure.

In other words, in order to achieve a higher track density (TPI) at a higher skew angle Ha in the perpendicular magnetic recording, the bottom surface 120W of the main magnetic pole structure 120 is worked to a trapezoidal or triangular shape to provide a bevel angle Ba and, by doing so, even if a relatively high bevel angle Ba is not provided, it is possible to achieve the higher track density (TPI) at the variable track pitch on the disk medium 11. It is to be noted that, if the skew angle Ha is lower than the bevel angle Ba, the track pitch Tp may be constant.

According to the present embodiment, for the disk drive using a perpendicular recording system write head having a bevel angle given by working the main magnetic pole structure to a trapezoidal or triangular shape, it is possible to achieve an effective variable track pitch configuration without lowering a perpendicular magnetic recording capability and to achieve a high track recording density.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A disk drive comprising:
a disk medium configured to allow perpendicular magnetic recording;
a magnetic head configured to include a read head for reading out perpendicular magnetic recorded data from the disk medium and a write head for effecting the perpendicular magnetic recording onto the disk medium, said write head having a main magnetic pole structure with a bottom surface formed to a trapezoidal or triangular shape and facing the disk medium; and
a rotary type actuator having a mounted magnetic head and configured to move it over the disk medium in a radial direction, in which those tracks recorded by the write head on the disk medium are such that, with respect to a bevel angle defined relative to said bottom surface and a skew angle of the magnetic head located by the rotary type actuator over the disk medium, a track pitch set based on the size of said bottom of the main magnetic pole structure, skew angle and bevel angle is variable in a radial position over the disk medium where the skew angle≧the bevel angle.

2. A disk drive according to claim 1, in which, in a radical position over the disk medium where the skew angle is less than the bevel angle, the track is so configured that the track pitch is constant.

3. A disk drive according to claim 1, in which, with MWW₀ representing a magnetic track width of the write head when the skew angle Ha is 0°; MRW₀, a magnetic read width of the read head; MT, a magnetic head length of the write head; and Tp, a track pitch Tp, the track is so configured as to satisfy the following equation:
2Tp=MWW₀·cos Ha+MT\sqrt{1+tan²Ba}·sin (Ha−Ba)+MRW₀·cos Ha (H)
provided that, Ha≧Ba

4. A disk drive according to claim 1, wherein, with MWW₀ representing a magnetic track width of the write head at a skew angle Ha=0°; MRW₀, a magnetic read width; MT, a magnetic head length of the write head; and Tp, a track pitch, the track is so configured as to satisfy the following equations:
MWW₀·cos Ha+MT\sqrt{1+tan²Ba}·sin (Ha−Ba)+MRW₀·cos Ha≦2Tp (I)
2Tp≦MWW₀·cos Ha+MT\sqrt{1+tan²Ba}·sin (Ha−Ba)+MRW₀·cos Ha+60 (J)
provided that, Ha≧Ba

5. A magnetic head applied to a disk drive using a disk medium allowing perpendicular magnetic recording, comprising:
a read head configured to read out perpendicular magnetic recorded data from the disk medium; and
a write head configured to effect perpendicular magnetic recording on the disk medium, said write head having a main magnetic pole structure with a bottom surface formed to a trapezoidal or triangular shape and facing the disk medium, and in which, with respect to a bevel angle defined relative to said bottom surface and a skew angle located over the disk medium, those tracks recorded on the disk medium are formed at a variable pitch in a radial position on the disk medium where the skew angle≧the bevel angle, the size of the bottom surface of the main magnetic pole structure and bevel angle matched to the track pitch are set.

6. A magnetic head according to claim 5, in which, with MWW₀ representing a magnetic track width of the write head when the skew angle Ha=0°; MRW₀, a magnetic read width of the read head; MT, a magnetic head length of the write head and Tp, the track pitch, the following equation is satisfied:
2Tp=MWW₀·cos Ha+MT\sqrt{1+tan²Ba}·sin (Ha−Ba)+MRW₀·cos Ha (K)
provided that, Ha≧Ba

7. A magnetic head according to claim 5, in which, with MWW₀ representing a magnetic track width of the write head when the skew angle Ha=0°; MRW₀, a magnetic read width of the read head; MT, a magnetic head length of the write head; and Tp, a track pitch, the following equations (L) and (M) are satisfied:
MWW₀·cos Ha+MT\sqrt{1+tan²Ba}·sin (Ha−Ba)+MRW₀·cos Ha≦2Tp (L)
2Tp≦MWW₀·cos Ha+MT\sqrt{1+tan²Ba}·sin (Ha−Ba)+MRW₀·cos Ha+60 (M)
provided that, Ha≧Ba
